(19) United States
(12) Patent Application Publication
(10) Pub. No.: US 2004/0133797 A1
(43) Pub. Date: Jul. 8, 2004

(54) Rights management enhanced storage

(75) Inventor: Gordon K. Arnold, Cary, NC (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/337,196

(22) Filed: Jan. 6, 2003

(51) Int. Cl. H04L 9/32

(52) U.S. Cl. 713/200; 713/182

(57) ABSTRACT

There is provided a system for managing content rights in data that is distributable over a network. The system includes a rights inspection module to determine whether the data is subject to a content right, and an authorization module to authorize a transmission of the data to a customer device in accordance with the content right.

### BACKGROUND OF THE INVENTION

1. Field of the Invention

The present invention relates to digital rights management, privacy management, and ad-hoc collaboration of on-line content including digital media. An embodiment of the present invention provides for integration of rights management into a file system, and integration of rights enforcement of content into a file system such that application access can be accomplished through a standard interface without requiring modification of the application. The integration of rights management into standard application interfaces enables a layering of rights management without application changes thus permitting more ubiquitous rights management.

2. Description of the Prior Art

“Content” is a term often used to describe information. Such information is often stored on a storage media such as a magnetic disk, an optical disk, a magnetic tape or an electronic memory. A digital representation of such content can be delivered from a storage device to a user or client, online. That is, over a network, such as an Intranet, the Internet or a cable television network. For the client, online delivery improves timeliness and convenience. For an owner or publisher of the content, online delivery reduces delivery costs as compared to delivery of a hard copy or tangible storage media.

The owner or publisher typically wishes to ensure receipt of a payment for the client's access to the content and also wishes for the client to observe certain restrictions on the use and further distribution of the content. Unfortunately, online delivery makes it relatively easy for a third party to obtain pristine digital content and to pirate the content at the expense and harm of the owner and publisher.

“Digital rights” relate to the property interest that an owner has in content stored in a digital media. Techniques for enforcing an owner's content restrictions, for example, by restricting the client's right to save content to a storage device, are presently available to owners. However, in order to make use of such content restrictions practical in a widely distributed online environment, there must be a mechanism by which a client can be readily identified and supplied with content in a secure manner. Prior art related to limiting access rights to digital content in an information system includes the several patents indicated below.

U.S. Pat. No. 4,827,508, U.S. Pat. No. 4,977,594, which is a division of the '508 patent, and U.S. Pat. No. 5,050,213, which is a continuation of the '594 patent, describe a database access system and method at a user site which permits authorized users to access and use the database and prevent unauthorized database use and copying. A facility is disclosed for measuring usage of the on-site database for purposes of billing the user according to the amount the database has been used. Periodically, the measured usage information is conveyed to the database owner while preventing the user from tampering with the measured usage information.

U.S. Pat. No. 5,436,972 describes a method for preventing inadvertent betrayal by a trustee of an escrowed digital secret. After unique identification data describing a user has been entered into a computer system, the user is asked to select a password to protect the system. All personal identifying data, together with the password, is encrypted with a trustee's public key and stored, for example, in the user's computer system as an escrow security record. The password is then used to encrypt all data on the user's disk. If at some point in time, the user forgets the password, the user contacts the trustee's, for example, the vendor or the manufacturer. The trustee utilizes documentary evidence presented by the alleged legitimate user and determines whether such evidence matches with the previously encrypted escrowed information stored in the escrow records created by the user. If the records agree, then the trustee has confidence that the true owner is making request and that revealing the secret password will not betray the owner's interest.

U.S. Pat. No. 5,557,518 describes a system to open electronic commerce using a trusted agent. A customer-trusted agent securely communicates with a first money module. A merchant-trusted agent securely communicates with a second money module. Both trusted agents are capable of establishing a first cryptographically-secure session. Both money modules are capable of establishing a second cryptographically-secure session. The merchant-trusted agent transfers electronic merchandise to the customer-trusted agent, and the first money module transfers electronic money to the second money module. The money module informs the trusted agents of the successful completion of payment and the customer may use the purchased electronic merchandise.

U.S. Pat. No. 5,557,765 discloses a system and method for data recovery. An encrypting user encrypts a method using a secret storage key (KS) and attaches a Data Recovery Field (DRF), including an Access Rule Index (ARI) and the KS to the encrypted message. The DRF and the encrypted message are stored in a storage device. To recover the storage key (KS) a decrypting user extracts and sends the DRF to a Data Recover Center (DRC) and issues a challenge based on Access Rules (ARs) originally defined by the encrypting user. If the encrypting user meets the challenge, the DRC sends the KS in a message to the encrypting user. Generally, KS need not be an encryption key but could represent any piece of confidential information that can fit inside the DRF. In all cases, the DRC limits access to decrypting users who can meet the challenge to find in either the ARs defined by the encrypting user or the ARs defined for override access.

U.S. Pat. No. 5,590,199 describes a system for authenticating and authorizing a user to access services on a heterogeneous computer network. The system includes at least one workstation and one authorization server connected to each other through a network. A user couples a personally protectable coprocessor (smart card) to the workstation by means of a bidirectional communications channel. The coprocessor is adapted to receive signals including first encrypted authentication information and decrypt the first encrypted authentication information using a preselected first key. The coprocessor is further adapted to assemble and encrypt second authentication information using a preselected second key and to transmit the encrypted second encrypted authentication information to the workstation. The workstation then communicates the information on to the network whereby the user is authenticated to access the network computer or service.

U.S. Pat. No. 6,098,056 describes a system and method for limiting access to and preventing unauthorized use of an owner's digital content stored in an information network and available to clients under authorized conditions. The network includes at least one server coupled to a storage device for storing the limited access digital content encrypted using a random-generated key, known as a Document Encryption Key (DEK). The DEK is further encrypted with the server's public key, using a public/private key pair algorithm and placed in a digital container stored in a storage device and including as a part of the meta-information that is in the container. The client's workstation is coupled to the server for acquiring the limited access digital content under the authorized condition. A Trusted Information Handler (TIH) is validated by the server after the handler provides a data signature and type of signing algorithm to transaction data descriptive of the purchase agreement between the client and the owner. After the handler has authenticated, the server decrypts the encrypted DEK with its private key and re-encrypts the DEK with the handler's public key ensuring that only the information handler can process the information. The encrypted DEK is further encrypted with the client's public key personalizing the digital content to the client. The client's program decrypts the DEK with his private key and passes it along with the encrypted content to the handler which decrypts the DEK with his private key and proceeds to decrypt the content for displaying to the client.

U.S. Pat. No. 6,330,670 describes a digital rights management operating system that protects rights-managed data, such as downloaded content, from access by untrusted programs while the data is loaded into memory or on a page file as a result of the execution of a trusted application that accesses the memory. To protect the rights-managed data resident in memory, the digital rights management operating system refuses to load an untrusted program into memory while the trusted application is executing or removes the data from memory before loading the untrusted program. If the untrusted program executes at the operating system level, such as a debugger, the digital rights management operating system renounces a trusted identity created for it by the computer processor when the computer was booted. To protect the rights-managed data on the page file, the digital rights management operating system prohibits raw access to the page file, or erases the data from the page file before allowing such access. Alternatively, the digital rights management operating system can encrypt the rights-managed data prior to writing it to the page file. The digital rights management operating system also limits the functions the user can perform on the rights-managed data and the trusted application, and can provide a trusted clock used in place of the standard computer clock.

IBM Corporation currently offers a digital rights management technology known as a Cryptolope™, which stands for cryptographic envelope technology. A Cryptolope object is used for secure, protected delivery of digital content. A cryptographic envelope uses encryption to prevent an eavesdropper from absconding with the content, and also uses a digital signature to offer an end user a guarantee that the content is genuine. A Cryptolope object ties usage conditions of the content to the content itself. For example, the content owner might specify that viewing the content can only be done with a special viewer. Or, for certain types of content, the owner might specify that it can only be delivered to a system that is capable of applying a digital watermark. Because the Cryptolope object is digitally signed, usage conditions cannot be tampered with without invalidating the cryptographic envelope. A Cryptolope object is a self-contained and self-protecting object, and can be delivered any way that is convenient. Thus, a Cryptolope object can be placed on a CD-ROM, mirrored to a file transfer protocol (FTP) site, or passed casually from a first user to a second user, all without breaking the underlying security.

The aforementioned prior art techniques are generally directed towards solutions that require a modification to a user's computer, or an installation of some special software on the user's computer. Often, such software is specific to a particular distributor, and as such, the user cannot readily obtain content from a distributor unless the user has an established relationship with the particular distributor. Also the digital rights owner needs to create a system for the rights enforcement rather than being able to use an existing system.

For example, consider a case of a customer that wishes to rent and download a movie from a video distributor via the Internet. To download the movie from a first video distributor, the customer would need to obtain a first software application that enforces the rights of the owner of the movie. To download the movie from a second video distributor, the customer would need to obtain a second, different, software application for enforcing the owner's rights. To further complicate the situation, if the customer thereafter wished to download music media from a music provider via the Internet, the customer would need to obtain yet another software application for enforcing the rights of the owner of the music media. This need for a plurality of different software applications is due, in part, to an absence of firm standards for the enforcement of rights. In addition the enforcement for different types of rights such as copyright, privacy, confidentiality, intellectual property rights are different for each system and are not consistently enforceable in prior art systems.

Thus, there is a need for an improved system for managing rights associated with online media.

### SUMMARY OF THE INVENTION

The present invention provides rights management for digital media that does not require a change to an existing software application, and can be achieved transparently to existing applications and methods of storing and retrieving digital content.

An embodiment of the invention is a system for managing content rights in data that is distributable over a network. The system includes a rights inspection module to determine whether the data is subject to a content right, and an authorization module to authorize a transmission of the data to a customer device in accordance with the content right.

Another embodiment of the invention is a system for managing content rights in data that is distributable over a network. The system includes a collection module to enable a publisher of the data to update a database of information relating to a content right in the data, a rights inspection module to determine whether the data is subject to the content right, and an authorization module to authorize a transmission of the data to a customer device in accordance with the content right. The rights inspection module is invoked in response to a request from a requester of the data, and the rights inspection module considers an identity of the requester and a role of the requester when making the determination.

### BRIEF DESCRIPTION OF THE DRAWINGS

FIG. 1 is a functional block diagram of a rights management system for reading digital content configured for employment of the present invention.

FIG. 2 is a functional block diagram of a rights management system for employment of the present invention and involved with a publication or writing of digital content to the rights management system.

### DESCRIPTION OF THE INVENTION

The present invention relates to management of rights in content that is distributed in electronic format. Electronic format is typically regarded as being a digital format, i.e., binary, but the present invention is not limited as such, and any suitable format may be employed. An enforcement of digital rights encompasses enforcement of copyrights and licensing rights, and access to media. Enforcement may also extend to enforcement of a confidentiality agreement with respect to the content or the privacy concerns with disclosure of the content.

The invention manages rights with respect to any transmitted media, including, for example, software, audio (e.g., music), video (e.g., television), where a customer wishes to download such media from a media provider. It can also be used to manage access to an interactive venue, such as a web site, where the customer may thereafter be granted access to proprietary content. It could also be used to protect medical images for which privacy rights management is required. For the purpose of clarity, certain aspects of the invention are presented herein in the context of an exemplary video distribution system where a customer wishes to download a movie from a video distributor.

On embodiment of the present invention is a rights management system that executes a method for managing content rights in data that is distributable over a computer network. The method includes determining whether the data is subject to a content right, and authorizing a transmission of the data to a customer device in accordance with the content right.

In another embodiment, the rights management system executes a method that includes enabling a publisher of the data to update a database of information relating to a content right in data, determining whether the data is subject to the content right, authorizing a transmission of the data to a customer device in accordance with the content right, and reporting of access records and statistics. The step of determining is invoked in response to a request from a requester of the data, and considers an identity of the requester and a role of the requester when making the determination.

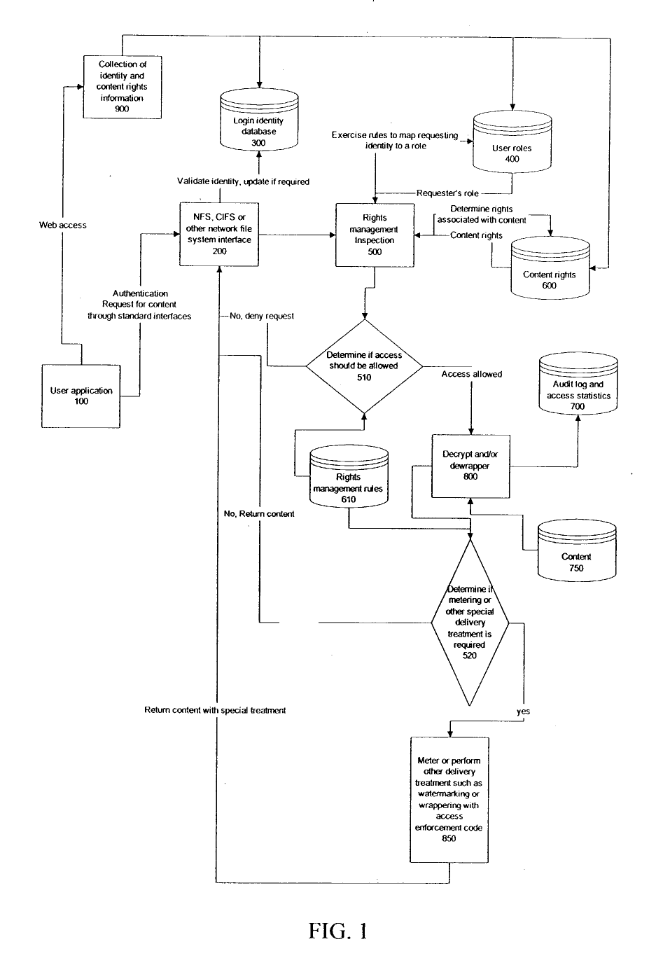

FIG. 1 is a functional block diagram of a computer network configured to include a rights management system in accordance with the present invention. The network can be implemented as any suitable data or communications network, where communication between components therein may be accomplished via wire, fiber optic or wireless resources. In its preferred embodiment, the network is implemented over the Internet. The principal components of the network include a client station 100 running a user application, a file system interface 200, a login identity database 300, a user roles database 400, a content rights database 600 and a rights management system that includes a rights management inspection process 500, an authorization process 510, a determination process 520, an audit log and access statistics database 700, a storage device 750, a decryption/dewrapping process 800, and a delivery process 850.

Network File System (NFS) and Common Internet File System (CIFS) are client/server applications that allow a computer to access a file on a remote device. NFS was developed by Sun Microsystems, and CIFS was developed by Microsoft Corporation. A daemon is a program that runs continuously and handles periodic service requests from a client station. Daemons are well known in the art, where, for example, a server of a page on the Web, i.e., the World Wide Web of the Internet, may have a daemon that waits for requests from Web clients. File system interface 200 is shown as containing an NFS/CIFS daemon to make clear that the present invention is contemplated as being compatible with these technologies. The daemon of file system interface 200 handles service requests from client station 100. Upon receipt of such a request, it forwards the request to rights management inspection process 500.

Storage device 750 provides for storage of the content being protected and for purposes of the present example contains a movie.

File system interface 200 and storage device 750 can be regarded for example as components of a network-attached storage (NAS) system. NAS is a form of storage, typically hard disk storage, set up with its own network address rather than being attached to a department computer that is serving applications to a network's workstation users. By removing storage access and its management from the department server, application programming and files can be served faster because they are not competing for the same processor resources. In an NAS system, an NAS file server, e.g., file system 200, is attached to a local area network, for example, an Ethernet network, and assigned an Internet protocol (IP) address. File requests are mapped by a main server to the NAS file server. An appropriate manner of deployment is to have the NFS, CIFS, FTP or other common Internet standard for file access deployed accessible to the Internet along with a web server that is collecting information associated with the rights management.

Client station 100 is a device that a customer uses to access content stored in the system. Client station 100 may be implemented on a general purpose microcomputer, such as one of the members of the Sun™ Microsystems family of computer systems, one of the members of the IBM™ Personal Computer family, and preferably includes a browser. A browser is a program used to view, download, upload, surf or otherwise access data via the Internet. Client station 100 could alternatively be implemented as an interface device, such as a television set top box (STB), into which the content from storage device 750 may ultimately be loaded for a contemporaneous or subsequent viewing or use by a customer.

Assume that a user at client station 100 wishes to read some content that is stored on storage device 750. To initiate file access, client station 100 sends a request for the content to file system interface 200. In the case of a web browser this is done using a standard interface without modification of the client's application for access.

The user application on client station 100 performs a login providing identity information. This is done using standard interfaces such as providing a user id and password, or presenting a digital certificate that can be cryptographically verified. Often the identity information may have already been established by some other common mechanism and the identity information is provided as part of the context of the request (for instance in an http header). The present invention is not dependent upon a particular authentication mechanism, and instead accommodates existing login methods deployed in the industry.

File system interface 200 authenticates the requesting identity as required by the customer chosen authentication mechanism chosen. Regardless of the method, the identity is validated against login identity database 300, an update made to the database, if required, includes context of the request such as network, access method, or entry point. By example, the identity may be anonymous with the identity being derived from the network context of the request. For instance, content that could be shared within an organization without restriction could derive the identity from the originating address information, while users outside of an internal firewall protected network would not be allowed access because the derived identity would be outside of the originating addresses known by the organization as internal and trusted. Another example is where within an Internet Service Provider the Point of Presence (POP) has some identity associated with the originating IP address based upon RADIUS login information exchanged during assignment of the IP address which could be referenced for login identity database 300.

The user application at client station 100 requests content by passing a standard request to the appropriate file system interface 200, including the content identification. The content request is unaware of the rights management enforcement and makes the request as it would to any NAS or file system.

File system interface 200 communicates the requesting identity and the requested content to rights management inspection process 500, which exercises rules mapping the requesting identity to a role, and determines whether the content is subject to a content right. A system administrator can define groups or roles, and the rules could consist of any rules for deriving the group or role associated with an identity, but by example could be a set of regular expression matching such as:

(a) If IP address is within my enterprise, then assign role of insider.

(b) If IP address is outside my enterprise, then assign role of outsider.

(c) If identity is a user id registered in our database with an account balance of greater than $20, then assign role of pre-paid subscriber.

(d) If identity is a user id registered in our database with an account balance of less than 0, then assign role of deadbeat.

(e) If identity is within the group publisher, then assign role of publisher.

(f) If identity is within the group distributor, then assign role of distributor.

(g) If identity is related to another identity or entity, such as a physician to patient relationship, then assign role of validated third party.

Thus by evaluation of rules, a role is associated with an identity. During this processing user roles database 400 is utilized for mapping of information during the evaluation of rules such as checking whether an identity is in a group or has a relationship to another identity.

Rights management inspection process 500 determines the rights associated with the content by exercising a similar set of rules as illustrated above for assigning a classification of the content. For instance the rules could be:

(a) If the content is not protected, then assign classification of unrestricted.

(b) If the content is protected and payment is required, then assign classification of pay per view.

(c) If the content is protected and privacy is of concern then assign classification of private.

These rules access content rights database 600, which is associated with content stored in storage device 750.

Processing proceeds to authorization process 510, which determines whether access is allowed and authorizes a transmission of the content to client station 100 in accordance with the content rights. A system administrator can configure a set of classifications. Rights management rules 610 are used to evaluate the permissibility of allowing access. Examples of rules for this type of evaluation could be:

(a) If the classification of the content is unrestricted, then permit access.

(b) If the classification of the content is pay per view and the role is pre paid subscriber, then permit access.

(c) If the classification of the content is pay per view and the role is deadbeat, then deny access.

(d) If the classification of the content is private and the role is validated third party, then permit access.

If access is not allowed then deny the request and return a negative response to the user application on client station 100. If access is allowed then continue with decryption/dewrapping process 800.

Decryption/dewrapping process 800 determines whether decryption or de-wrappering of the data is required, and if yes, performs the required operations. The wrappering process consists of adding a header and potentially a trailer to the content in effect surrounding it with meta-data pertaining to the rights management. De-wrappering consists of removing the header and trailer and restoring the content back to its original form. For instance one implementation of the wrapper would be to use XML to encode the pertinent data regarding the originator of the content, owner of the rights, and the nature of the content. Rights management rules 610 are consulted for a determination of whether any additional processing is required on the content prior to delivery to client station 100.

Decryption/dewrapping process 800 also includes a usage module to update audit log and access statistics database 700, which contains information relating to usage of the content. For example, the usage information may include usage statistics such that content owners could use the statistics to verify proper usage of their content and for purposes of calculating royalties. Decryption/dewrapping process 800 could also write an access audit log entry to audit log and access statistics database 700 if, for instance, the content was classified as private and there is a legal requirement for an audit log to be kept of access.

Processing continues with determination process 520, which determines whether special treatment such as metering, watermarking, or wrappering with an enforcement application is required. Rights management rules 610 are used to determine which additional special treatment may be required. If no special treatment is required, then return the content to client station 100, otherwise processing continues with delivery process 850.

Delivery process 850 performs special treatment and returns the content to client station 100. The special treatment could include, but would not be restricted to, the following methods:

(1) Metering. This is a technique where the rate at which the content is delivered is consistent with on-line viewing, but would not support downloading of content such as a movie faster than real time viewing.

(2) Watermarking. This is a technique of embedding a digital fingerprint inside of a digital media object such that any further distribution of the content could be traced, based upon the inclusion of the watermark.

(3) Wrappering of content with a rights enforcement application. For example, the media viewer is triggered to enforce that the content cannot be saved and can only be viewed on the screen.

If the access was denied, the requester, i.e., the user at client station 100, has the option of going to a web page 900 that gathers identity information, verifies credentials and stores them to login identity database 300 and user roles database 400.

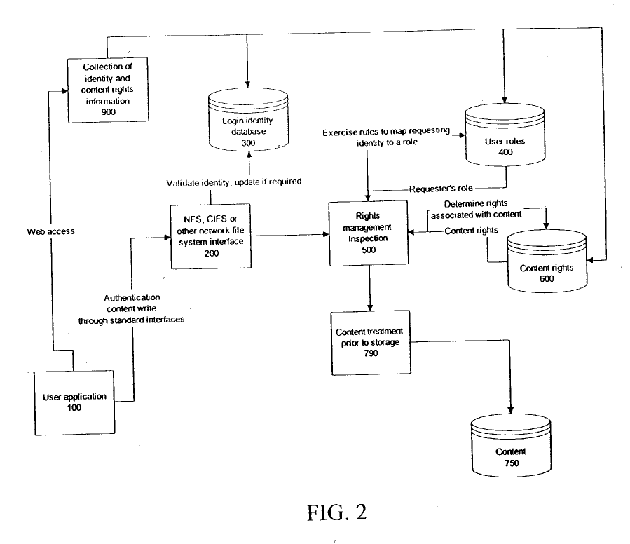

FIG. 2 is a functional block diagram of a rights management system showing processes for publication or writing of content to the rights management system. If the user is depositing content, then the collection of content rights is done through web page 900 and content rights database 600 and roles database 400 are updated.

The user application at client station 100 performs a login using similar techniques as described previously for the content read, as described in association with FIG. 1. The user application interacts with a data collection application, for illustration purposes a web page, to collect information associated with the content that is to be published. This information includes:

(1) the identities and roles that are associated with the content, which are then stored in login database 300 and user roles database 400;

(2) the particular rights associated with the content, which are then stored in content rights database 600; and

(3) any special treatment to which the content should be subjected when it is read, which are obtained by a content treatment process 790.

Note that these may be specified either per individual content selection, or for a group of content.

In a preferred embodiment of the present invention, all rights management specification is done out of band, i.e. not by the user's application, thus permitting the content flow to be unchanged and able to be accessed by the widest variety of unmodified user applications. The content is wrapped with rights management information that is added transparently during the write and removed transparently during the read. Some of the information required for processing is derived from the environment of the request rather than explicitly by the application.

Although the invention is presented herein in the context of distributing a movie, it is suitable for an online distribution of any appropriate content. As such it may be employed in fields as diverse as publishing, advertising, e-learning, entertainment, streaming video, control systems. The system could be used for collaboration requiring access to protected content. The system could be used for protecting private information such as medical records.

The rights management system of the present invention may be implemented by special-purpose hardware, that is, hardware modules specifically designed to perform the functions described herein. However, the rights management system can also be implemented in software as a set of program modules that are stored in a memory (not shown), and that contain instructions for controlling a processor (not shown) that, in turn, performs the functions.

Also, note that the instructions can reside on an external storage media (not shown) for subsequent loading into the memory. Such a storage media can be any conventional storage media, including, but not limited to, a floppy disk, a compact disk, a magnetic tape, a read only memory, or an optical storage media. The storage media could also be a random access memory, or other type of electronic storage, located on a remote storage system and coupled to the rights management system.

It should be understood that various alternatives and modifications of the present invention could be devised by those skilled in the art. The present invention is intended to embrace all such alternatives, modifications and variances that fall within the scope of the appended claims.

What is claimed is:

1. A system for managing content rights in data that is distributable over a network, comprising:
a rights inspection module to determine whether said data is subject to a content right; and
an authorization module to authorize a transmission of said data to a customer device in accordance with said content right.

2. The system of claim 1, wherein said rights inspection module receives a request for said data via a daemon.

3. The system of claim 1, wherein said rights inspection module is remotely located from a client station, and receives a request for said data from said client station via a file system interface.

4. The system of claim 1, wherein said data resides on a network attached storage (NAS) device that is remotely located from said system.

5. The system of claim 1, wherein said rights inspection module designates a classification for said data selected from the group consisting of unrestricted, pay-per-view and private.

6. The system of claim 1,
wherein said rights inspection module is invoked in response to a request from a requester of said data, and
wherein said rights inspection module considers an identity of said requester and a role of said requester when making said determination.

7. The system of claim 6, wherein said role is selected from the group consisting of:
(a) an insider, based on said requester sending said request from an Internet protocol (IP) address inside of an enterprise;
(b) an outsider, based on said requester sending said request from an Internet protocol (IP) address outside of an enterprise;
(c) a pre-paid subscriber, based on said requester having an account balance of greater than a predetermined value;
(d) a deadbeat, based on said requester having an account balance of less than a predetermined value;
(e) a group title, based on said requester being a member of a particular group; and
(f) a validated third party, based on said requester having a relationship with a third party.

8. The system of claim 7,
wherein said rights inspection module designates a classification for said data selected from the group consisting of unrestricted, pay-per-view and private, and
wherein said authorization module evaluates a condition selected from the group consisting of:
(a) if said classification is unrestricted, then permit access;
(b) if said classification is pay per view and said role is pre paid subscriber, then permit access;
(c) if said classification is pay per view and said role is deadbeat, then deny access; and
(d) if said classification is private and said role is validated third party, then permit access.

9. The system of claim 1,
wherein said rights inspection module queries a database of information relating to said content right, and
wherein said system further comprises a collection module to enable a publisher of said data to update said database.

10. The system of claim 1, further comprising a treatment module to apply a treatment to said data prior to said transmission, wherein said treatment is selected from the group consisting of:
(a) decrypting said data;
(b) dewrapping said data;
(c) metering said data;
(d) watermarking said data; and
(e) wrappering said data with an access enforcement code.

11. The system of claim 1, further comprising a usage module to update a database of information relating to usage of said data.

12. A system for managing content rights in data that is distributable over a network, comprising:
a collection module to enable a publisher of said data to update a database of information relating to a content right in said data;
a rights inspection module to determine whether said data is subject to said content right;
an authorization module to authorize a transmission of said data to a customer device in accordance with said content right; and
an audit and usage tracking module for reporting of access records and statistics,
wherein said rights inspection module is invoked in response to a request from a requester of said data, and
wherein said rights inspection module considers an identity of said requester and a role of said requester when making said determination.

13. The system of claim 12, wherein said rights inspection module receives said request via a daemon.

14. The system of claim 13, wherein said rights inspection module is remotely located from a client station, and receives said request for said data from said client station via a file system interface.

15. The system of claim 12, wherein said data resides on a network attached storage (NAS) device that is remotely located from said system.

16. The system of claim 12, further comprising a treatment module to apply a treatment to said data prior to said transmission, wherein said treatment is selected from the group consisting of:
(a) decrypting said data;
(b) dewrapping said data;
(c) metering said data;
(d) watermarking said data; and
(e) wrappering said data with an access enforcement code.

17. The system of claim 12, further comprising a usage module to update a database of information relating to usage of said data.

18. A storage media containing instructions for controlling a processor to managing content rights in data that is distributable over a network, said storage media comprising:
a rights inspection module for controlling said processor to determine whether said data is subject to a content right; and
an authorization module for controlling said processor to authorize a transmission of said data to a customer device in accordance with said content right.

19. The storage media of claim 18, further comprising a usage module for controlling said processor to update a database of information relating to usage of said data.

20. A storage media containing instructions for controlling a processor to managing content rights in data that is distributable over a network, said storage media comprising:
a collection module for controlling said processor to enable a publisher of said data to update a database of information relating to a content right in said data;
a rights inspection module for controlling said processor to determine whether said data is subject to said content right;
an authorization module for controlling said processor to authorize a transmission of said data to a customer device in accordance with said content right; and
an audit and usage tracking module for reporting of access records and statistics,
wherein said rights inspection module is invoked in response to a request from a requester of said data, and
wherein said rights inspection module considers an identity of said requester and a role of said requester when making said determination.

21. A method for managing content rights in data that is distributable over a network, comprising:
determining whether said data is subject to a content right; and
authorizing a transmission of said data to a customer device in accordance with said content right.

22. A method for managing content rights in data that is distributable over a network comprising:
enabling a publisher of said data to update a database of information relating to a content right in said data;
determining whether said data is subject to said content right;
authorizing a transmission of said data to a customer device in accordance with said content right; and
reporting of access records and statistics,
wherein said determining is invoked in response to a request from a requester of said data, and
wherein said determining considers an identity of said requester and a role of said requester when making said determination.

23. A system for managing content rights in data that is distributable over a network, comprising:
means for determining whether said data is subject to a content right; and
means for authorizing a transmission of said data to a customer device in accordance with said content right.
